(19) United States
(12) Patent Application Publication
(10) Pub. No.: US 2021/0406936 A1
(43) Pub. Date: Dec. 30, 2021

(54) Preservation of Price Calculation Data in Performance of Price Calculation Operations

(71) Applicant: salesforce.com, inc., San Francisco, CA (US)

(72) Inventors: Mitchell Christensen, Livermore, CA (US); Parth Vijay Vaishnav, Newark, CA (US)

(21) Appl. No.: 16/910,436

(22) Filed: Jun. 24, 2020

(51) Int. Cl. G06Q 30/02; G06Q 20/08; G06Q 10/10; G06Q 40/00; G06Q 30/06; G06T 11/20

(52) U.S. Cl. CPC G06Q 30/0206; G06Q 20/0855; G06Q 10/10; G06T 11/206; G06Q 30/0611; G06Q 30/0633; G06Q 40/12

(57) ABSTRACT

Preservation of price calculation data in performance of price calculation operations is described. An example of a system includes one or more processors, a memory, an API to receive requests, a pricing service to generate price calculations, and price data functions to perform operations on price calculation data, wherein in response to a request for price calculation for a first transaction the system is to generate a unique transaction identifier; record context data for the price calculation; calculate a pricing result for each of one or more sales items and collect price calculation data for each sales item; aggregate the pricing results to generate a final pricing result, generate a price calculation data set for the first transaction including at least the transaction identifier, the context data, and the price calculation data for the sales items, and store the generated price calculation data set in the memory.

### TECHNICAL FIELD

Embodiments relate to techniques for computer operations. More particularly, embodiments relate to preservation of price calculation data in performance of price calculation operations.

### BACKGROUND

In business operations, the generation of price calculations is often a computationally intensive task. Each sales item of a large sales order or other pricing transaction may require a different price calculation method, with each method requiring numerous processes, with each process being based on either an input or a result of a prior process.

Because of the nature providing calculations, any adjustment in any portion of a price calculation, such as modification of a calculation, addition of a discount, change in quantity of purchase, or similar adjustment, can require a full recalculation of the pricing. For this reason, back and forth adjustments with a customer on a purchase or quote generally requires the performance of multiple full pricing processes.

Further, if there are issues regarding a previous price calculation process that require auditing or investigation, there is generally little information available regarding how the pricing result was reached. While the final pricing outcome and the date of the price calculation may be available, this will not explain how a particular result was reached.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of a computing platform including generation and application of price calculation data according to some embodiments;

FIG. 2 is an illustration of preservation and use of price calculation data for incremental price calculation, auditing, and visualization according to some embodiments;

FIG. 3A is a flowchart to illustrate a process for collection and preservation of price calculation data in a price calculation operation according to some embodiments;

FIG. 3B is a flowchart to illustrate a process for generation of a price calculation data set according to some embodiments;

FIG. 4 is a flowchart to illustrate a process for incremental price calculation utilizing a generated price calculation data set according to some embodiments;

FIG. 5 is a flowchart to illustrate a process for generation of an audit trail or explanation for a sales transaction utilizing a price calculation data set according to some embodiments;

FIG. 6A is a flowchart to illustrate a process for generating a visualization of a price calculation operation utilizing a price calculation data set according to some embodiments;

FIG. 6B illustrates a price waterfall illustration generated based on a price calculation data set, according to some embodiments;

FIG. 7 illustrates a block diagram of an environment in which a preservation of price calculation data in performance of pricing operations may be implemented according to some embodiments; and

FIG. 8 illustrates further details of an environment in which preservation of price calculation data in performance of pricing operations may be implemented according to some embodiments.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In some embodiments, an apparatus, system, or process is to provide for collection and preservation of price calculation data in performance of pricing operations. In some embodiments, price calculation data for a pricing transaction is collected and preserved such that subsequent requests to provide incremental price calculation in which calculations are limited to modified elements to improve efficiency in pricing operations, and to improve customer experience in requesting sales transactions or receiving price quotes or bids.

In some embodiments, an apparatus, system, or process provides for incremental pricing of products. Instead of pricing an entire sales transaction with each request for a price calculation, data is preserved (including sales transaction, pricing plan, intermediate price calculations, etc.) in memory such that subsequent requests to price the same sales transaction may be reduced to delta price calculation requests, wherein a delta price calculation request refers to an operation to only calculate what is impacted by the most recent change to the sales transaction.

In some embodiments, an apparatus, system, or process further preserves audit data, with information and precise computation trails for pricing being provided so that customers can understand how a price was generated. In some embodiments, an apparatus, system, or process further includes illustration/visualization provided using the collected price calculation data set. In this manner, a visual reference is provided to illustrate a pricing method or a pricing waterfall to assist customers in understanding how the pricing engine applies pricing functions for the calculation of price.

In some embodiments, price calculation data collection is provided as a part of a pricing engine, with implementation hooks being provided to add pricing and audit information with finely grained details including, but not limited to, the pricing function, the price before the application of any function, the end result for the application of the function, and any other details that an administrator, sales manager, end user, or other party may wish to have to understand how a price was generated. In some embodiments, the data collection can also be exposed as part of an interface for customization so that parties may inject additional information that they wish to add to their audit.

As used herein, “sales transaction” or “transaction” refers to any sales order, quote, bid, shopping cart, or other inquiry regarding one or more sales items, with each sales item including a certain quantity.

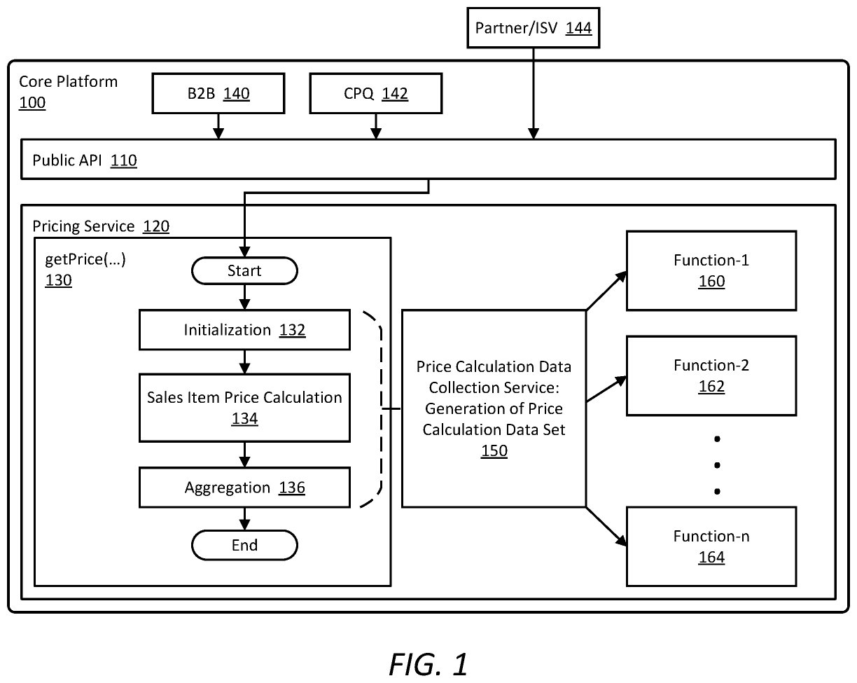

FIG. 1 is an illustration of a computing platform including generation and application of price calculation data according to some embodiments. As illustrated, a core computing platform 100 may provide multiple services including, but not limited to, a pricing service 120 (the host pricing service) to provide pricing operations for multiple different types of sales operations for multiple clients. The core platform 100 may include numerous other operations and functions that are not described herein.

The core platform 200 may include a public application programming interface (API) 110 for connection of multiple different types of clients that may generate operation requests, including requests to the pricing service 120 for price calculations. The requests may include business to business (B2B) requests 140 and configure-price-quote (CPQ) requests 142 provided within the core platform 100, and partner or independent software vendor (ISV) requests 144 received from outside the core platform 100. Other types of requests for price calculations may also be received.

The pricing service 120 in particular includes a getPrice function 130 to determine pricing for one or more sales items in a transaction, the sales items being any combination of goods and services, and to generate a price calculation data set based on the pricing operation. In a basic operation, the getPrice function for a particular request includes initialization of the pricing operation 132, sales price calculation for each sales item of the request 134, and aggregation of the price calculations to generate a pricing output 136 to be provided to the client. In some embodiments, the sale item price calculation 134 includes application of a particular pricing method for a sales item, wherein each sales item may utilize a different pricing method.

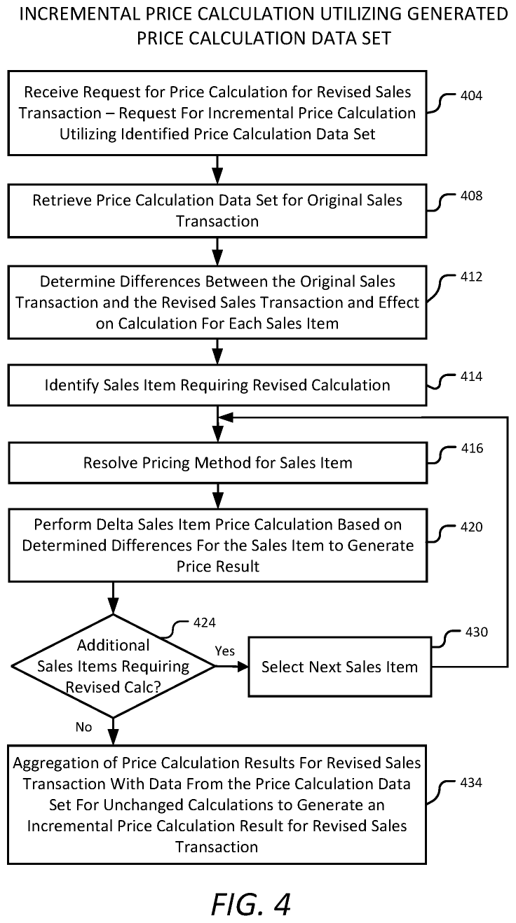

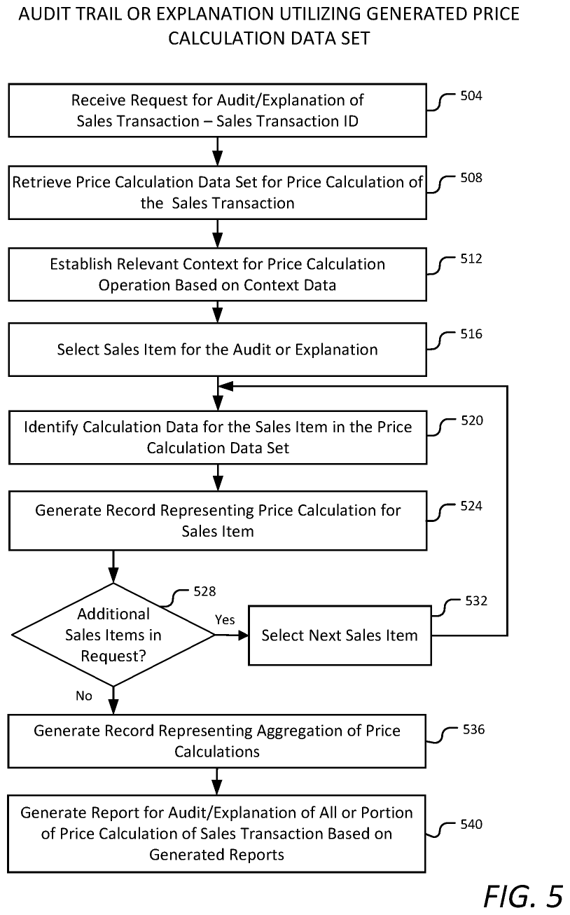

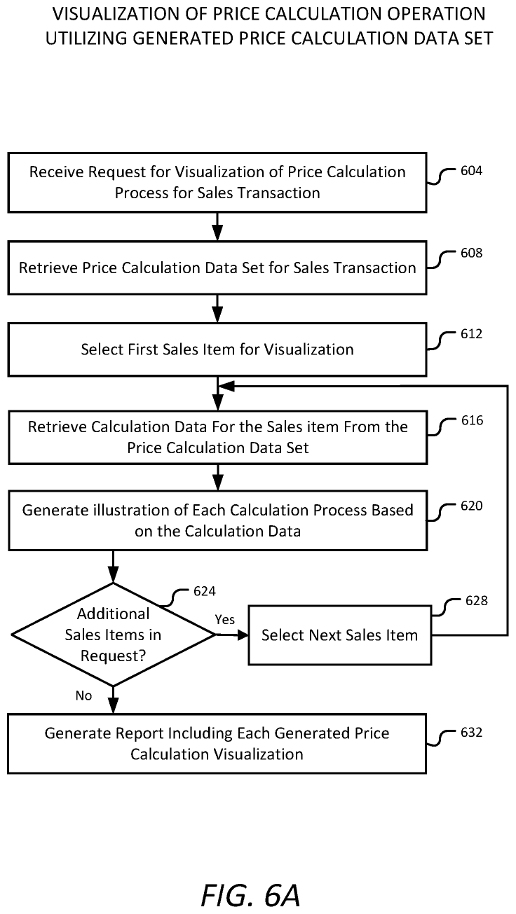

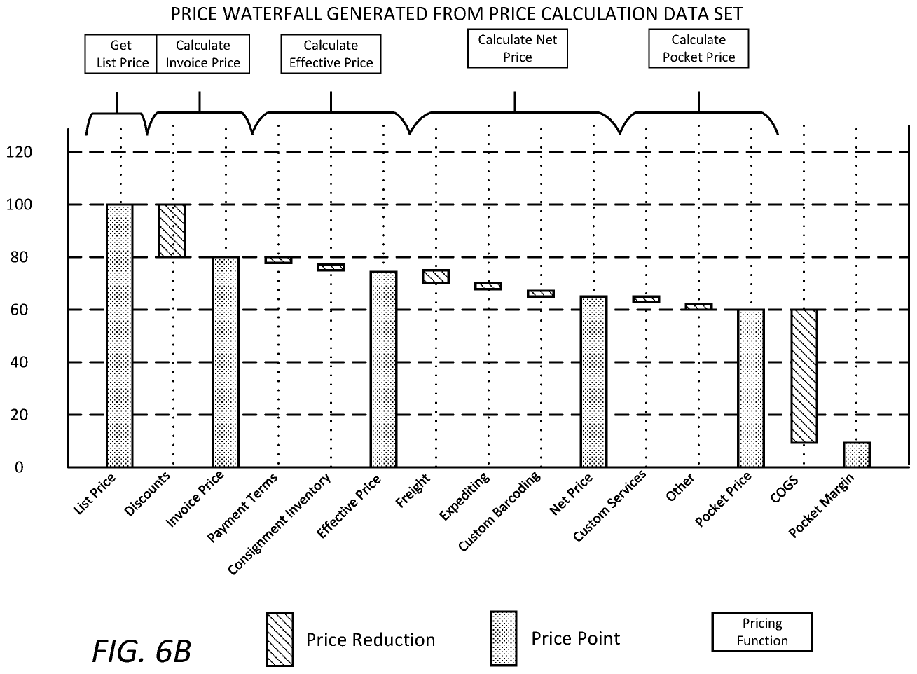

In some embodiments, the pricing service 120 include a price calculation data collection service 150, the service to generate a price calculation data set based at least in part on a calculation of pricing for a particular transaction. The pricing service may further include one or more price data functions that may be selected to receive one or more price calculation data sets, each price data function to perform one or more operations based on such data sets. The price data functions are illustrated as Function-1 160, Function-2 162, and continuing to Function-n 164. The price data functions may include, but are not limited to, operations for incremental price calculation for a modified transaction, as further illustrated in FIG. 4; auditing of sales transactions, as illustrated in FIG. 5; or visualization of price calculations, as illustrated in FIGS. 6A and 6B.

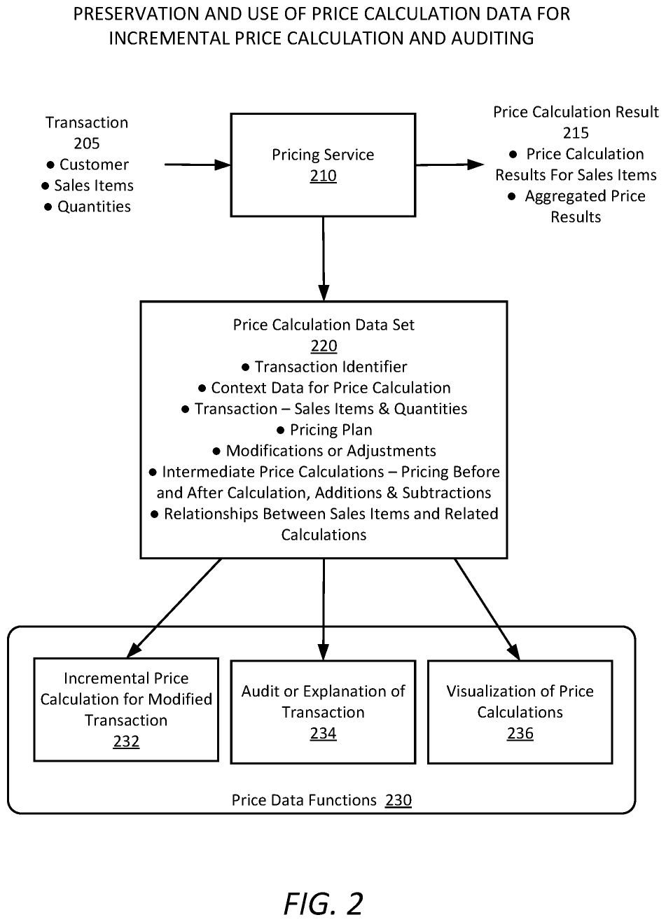

FIG. 2 is an illustration of preservation and use of price calculation data for incremental price calculation, auditing, and visualization according to some embodiments. While calculation of pricing for a small number of sale items may be performed relatively quickly, the price calculation becomes much more complicated as the number of sales items increases. After the price calculation is completed, any modification in the sales transaction conventionally requires that the full pricing process be repeated to obtain a new result.

Once the price calculation operation is completed, it is difficult to audit the pricing process to provide an explanation without re-creating the price calculation. However, the re-creation of the pricing process may be problematic because the context of the sales transaction may have changed, thus potentially changing the pricing. For example, if the application of particular pricing contract or arrangement depends on factors such as the total amount of sales at that time, the application of a discount within a particular time window, or other context dependent calculations, all such factors must be known in order to generate a correct pricing result.

In some embodiments, an apparatus, system, or process is to collect and preserve price calculation data in a manner and form that allows for incremental price calculation in which a price calculation operation for a transaction may be performed with delta price calculations. As used herein delta price calculation means that only those changes which have been made to the sales transaction since the last price calculation for that sales transaction need to be provided to the pricing engine API. However, in order to support incremental price calculations, the pricing engine will need to preserve intermediate price calculations and any related information.

In some embodiments, a sales transaction 205 is provided to a pricing service 210, the pricing service being illustrated in more detail in FIG. 1. The sales transaction 205 may in the form of an order, quote, bid, or other transaction. The sales transaction 205 may be associated with a particular customer, and will include a set of one or more sales items (potentially a very large number of items) and a quantity for each item in the sales transaction. The pricing service 210 is generally intended to generate a price calculation result 215, the price calculation result 215 including, for example, pricing for each sales item and an aggregated pricing result. Other items may also be included in the price calculation result 215.

In some embodiments, the pricing service 210 is to automatically generate a price calculation data set 220 based on the calculation of the pricing result 215 for the sales transaction 205. In some embodiments, the price calculation data set is generated contemporaneously with the price calculation, thus enabling the preservation of the current data and actual calculations for the pricing of the sales transaction. The price calculation data set 220 may be utilized in one or more price data functions 230, wherein the price data functions 230 may include incremental price calculation for a modified sales transaction 232, as further illustrated in FIG. 4; auditing or explanation of sales transactions 234, as illustrated in FIG. 5; or visualization of price calculations 236, as illustrated in FIGS. 6A and 6B.

In some embodiments, the price calculation data set 220 may include, but is not limited to:

(a) A designated sales transaction identifier for use in identifying and tracking price calculations for specific sales transactions;

(b) Context information for a sales transaction, which may include a client identifier, data and time of the price calculation, sales contract terms, sales history information, and other context information to allow identification of factors that influence the price calculation;

(c) Sales transaction data, including at least identification of the sales items and quantities for the sales transaction;

(d) Identification of the pricing plan utilized in the price calculation;

(e) Any pricing modifications or adjustments applied in the price calculation;

(f) Intermediate price calculations, including pricing before and after each calculation, and any additions or subtractions made in the price calculations; and

(g) Relationships between sales items and related calculations, which may include, but is not limited to, line item groups and derived pricing dependencies for line items. For example, calculations for a total across a line item group are generated and retained.

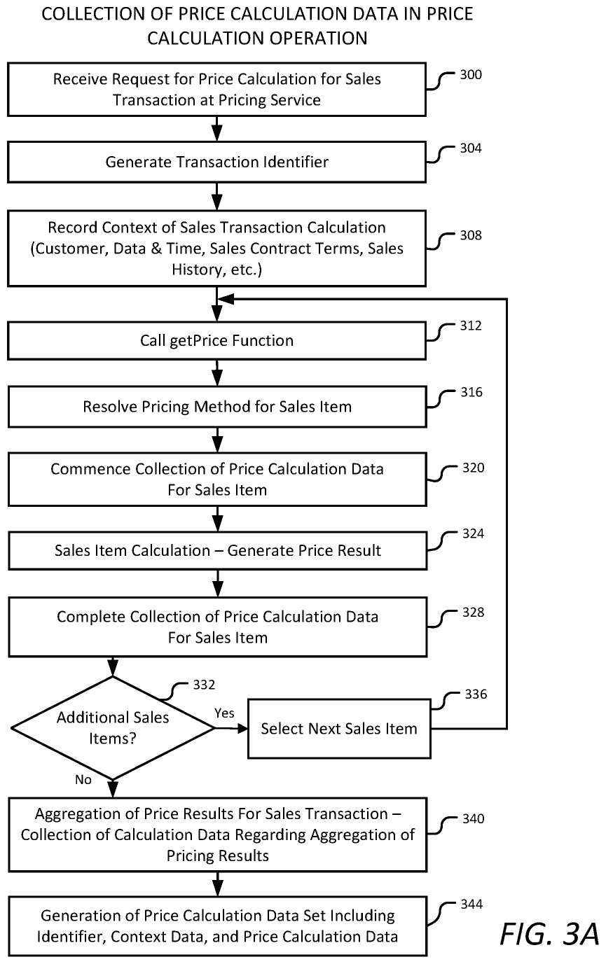

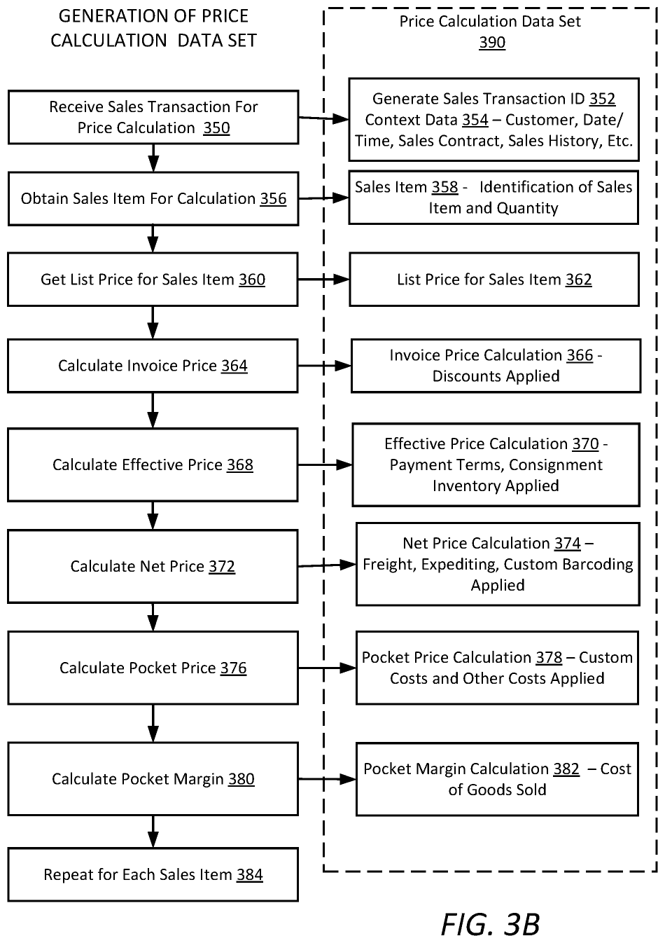

FIG. 3A is a flowchart to illustrate a process for collection and preservation of price calculation data in a price calculation operation according to some embodiments. In some embodiments, upon receiving a request for price calculation for a sales transaction including one or more sales items at a pricing service 300, wherein the pricing service may include pricing service 120 illustrated in FIG. 1, the pricing service is to generate a unique transaction identifier for the sales transaction 304. The transaction identifier may be utilized to retrieve data when required for operation of one or more selected price data functions, such as functions including, but not limited to, incremental price calculation, auditing of the sales transaction, or visualization of the sales transaction. The price data functions may be as illustrated in FIG. 1 (functions 160-164) and FIG. 2 (price functions 230). The pricing service may further operate to record context data for the sales transaction 308, wherein the context data may include, but is not limited to, identification of an associated customer for the sales transaction; a date, time, or both for the sales transaction calculation, sales contract terms, sales history information, and other context information to allow identification of factors that influence the price calculation.

The process may continue with calling a function for price calculation 312, such as the getPrice function 130 illustrated in FIG. 1, and resolving a pricing method for a sales item 316. In some embodiments, the process is to commence collection of price calculation data for the calculation of the sales item 320, as further illustrated in FIG. 3B. Collection of price calculation data may include collection of data regarding relationships between sales items and related calculations, which may include calculations related to line item groups (such as calculations for a total across a line item group) and derived pricing dependencies. The process continues with the sale price calculation and generation of the pricing result for the sales item 324, and completion of the collection of the price calculation data for the sales item 328.

The process may then proceed with a determination whether there are any additional sales items for calculation 332, and, if so, a next sales item is selected 336 and the process can return to calling the getPrice function 312 and resolving the pricing method for the next sales item 316. If there are no additional sales items for calculation 332, the process continues with aggregation of the pricing results for the sales transaction 340. In some embodiments, the process further include collection of price calculation data regarding the aggregation of pricing results (wherein the aggregation may include calculation of totals and application of one or more factors to the total values). In some embodiments, a price calculation data set is then generated for the sales transaction 344, wherein the price calculation data set includes at least the unique identifier for the sales transaction, the context data for the sales transaction, and the collected price calculation data for each one of the one or more sales items of the sales transaction. In some embodiments, price calculation data set further includes collected calculation data for the aggregation of pricing results.

In some embodiments, the generation of the price calculation data set may include one or more additional processes that are not illustrated, such as application encryption processing or data integrity processing to maintain the security and integrity of the collected data for future application.

FIG. 3B is a flowchart to illustrate a process for generation of a price calculation data set according to some embodiments. As illustrated in FIG. 3B, a process includes receiving a sales transaction for a price calculation 350, the sales transaction including at least one or more sales items and a quantity of each sales item. In some embodiments, the process proceeds with generating a sales transaction identifier 352, the identifier being a unique value to allow the sales transaction to be identified and retrieved. Further, the process may include collecting and preserving context data for pricing of the sales transaction 354, including, for example, collecting and preserving a client identifier, data and time of the price calculation, sales contract terms, sales history information, and other context information to allow identification of factors that influence the price calculation.

The process then continue with obtaining a sales item for processing 356, and preserving sales item data 358, including identification of the sales item and the quantity of the sales item for the sales transaction. The process then will proceed with performing the price calculations for the sales item, and preserving calculation data for each calculation process involved in the price calculation. In a particular example, the process may include:
Get list price for sales item 360—Preserve list price 362.
Calculate invoice price 364—Preserve invoice price calculation 366, including any discounts applied.
Calculate effective price 368—Preserve effective price calculation 370, including payment terms, consignment, and inventory costs applied.
Calculate net price 372—Preserve net price calculation 374, including freight, expediting, and custom barcoding costs applied.
Calculate pocket price 376—Preserve pocket price calculation 378, including custom costs and other costs applied.
Calculate pocket margin 380—Preserve pocket margin calculation 382, including the cost of goods sold.

The processes for calculation and data preservation for the sales item 356-382 then may be repeated for each sales item of the sales transaction 384, with the resulting data for all sales items being aggregated to generate the price calculation data set 390. In some embodiments, calculation data may include calculation data for the aggregation of the data for the sales items, including any calculation of totals or the application of one or more factors to such totals to generate a final pricing result.

As described with regard to FIG. 3A, the generation of the price calculation data set may include one or more additional processes that are not illustrated, such as application encryption processing or data integrity processing to maintain the security and integrity of the collected data for future application.

FIG. 4 is a flowchart to illustrate a process for incremental price calculation utilizing a generated price calculation data set according to some embodiments. As illustrated in FIGS. 3A and 3B, a price calculation data set may be generated based on a particular sales transaction. In some embodiments, a request for a pricing calculation may be received for a revised sales transaction, the sales transaction being a revision of the prior sales transaction for which pricing has been completed and for which a price calculation data set has been generated 404. More specifically, the request for price calculation may include a request for a function providing for an incremental price calculation utilizing an identified price calculation data set.

In some embodiments, the price calculation data set for the original sales transaction pricing operation 408, wherein data set may be retrieved based on a unique identifier generated for and associated with the data set. The process proceeds with determination of any differences between the original sales transaction and the revised sales transaction and the effect of the differences on the price calculation for each sales item 412.

In some embodiments, a sales item of the revised sales transaction requiring a revised calculation (i.e., the calculation for the sales item has been affected by the revision to the sales transaction, and at least a portion of the calculation for the sales items needs to be performed) is selected 414. The pricing method for the sales item is resolved 416, and a delta sales item calculation is performed based on the determined differences for the sale item between the original sales transaction and the revised sales transaction 420. The performance of the delta sales item calculation is limited to the identified differences and resulting effects on calculation of each sales item.

For example, a calculation for a first sales item may be modified because of a change in quantity; a calculation of a second sales item may be affected by the change in quantity in the first item even if there is no change in quantity of the second sales item if there is a dependency between the pricing of the first sales item and the second sales item; and a calculation of a third sales item may not affected by the calculations of for the first and second sales items if there are not any relevant dependencies in the calculations. Further, a delta calculation may be limited to a portion of a calculation of pricing for a sales item if only a portion of the calculation is affected by the modification of the sales transaction. In some embodiments, if the effect of a modification is not discernable in comparison, the delta calculation may fall back to a full calculation of any or all sales items.

In some embodiments, determinations regarding differences for sale items between the original sales transaction and the revised sales transaction include differences for relationships between sales items and related calculations, such as line item groups and derived pricing dependencies. In a first example, a calculation for a total for a line item group is stored, and determining differences for sales items includes determining that the stored group total remains valid if no line items in the line item group have changed. In a second example, for a derived pricing dependency that is stored, determining differences for sales items includes determining that a line item having a price derived from one or more other line items remains valid if none of the other line items has changed.

The process then proceeds with a determination whether there are any additional sales items requiring revised calculation 424. If so, then a next sales item is selected 430, the pricing method for the sales item is resolved 416, and the delta sales item price calculation is performed 420.

If there are no additional sales items 424, the pricing results for the revised sales transaction are aggregated with data from the price calculation data set for unchanged calculations to generate an incremental price calculation result for the full revised sales transaction 434.

In a specific example, a sales representative may be editing a reasonably large (such as 100 sales items) quote, and changes the quantity of a particular sales item. In a conventional operation, the pricing engine would generally require recalculation of the pricing of the revised sales transaction. In some embodiments, a pricing engine is only required to recalculate the respective sales item and any other sales items that depend on such sales item (for example, a percentage of a total line item in a quote may be affected). The process may and then aggregate and update the sales transaction totals.

Thus, in order for a requesting party to make use of incremental price calculations, the price engine returns a transaction identifier in the pricing results. The client then can pass that transaction identifier for utilization in future requests. In some embodiments, party may specify with the initial request for price calculation whether incremental price calculation is desired. (Full pricing may be preferable if there are a large number of changes in the sales transaction as the delta price calculation may not provide sufficient processing savings in such case.)

It is noted that a price calculation data set may be generated during the incremental price calculation process, with the processes illustrated in FIGS. 3A and 3B being adjusted according to the delta processing for the incremental price calculation and the data from the previous price calculation data set being utilized as appropriate. For example, certain calculations may not be modified in the incremental price calculation, and thus the data from the previous calculations may be copied into the new data set. In this matter, the generation of the price calculation data set may be limited to adding, subtracting, or replacing data in response to the delta calculations for the incremental price calculation.

FIG. 5 is a flowchart to illustrate a process for generation of an audit trail or explanation for a sales transaction utilizing a price calculation data set according to some embodiments. After the generation of a pricing result for a particular sales item, there may be a request for a function providing for an audit or explanation of the pricing process from a customer or party. However, the request may be received some time after the pricing result was generated. In such circumstances, it may be very difficult to recreate the pricing process because many factors may have changed between the time of the pricing and the audit or explanation request. This may require research of past conditions, and certain facts may no longer be available if a historical record of all pricing effects is not available.

In some embodiments, an audit trail or explanation of a pricing process is generated based on a price calculation data set, such as illustrated in FIGS. 3A and 3B. The price calculation data set is generated contemporaneously with the price calculation, thus enabling the preservation of the current data and actual calculations for the pricing of the sales transaction. In this way, the audit or explanation may be generated automatically, thereby providing a more accurate and complete result while saving large amounts of time and effort in the generation of the audit or explanation.

In some embodiments, a request for an audit or explanation of all or a portion (one or more sales items) of a sales transaction is received 504, wherein the request includes a transaction identifier for a price calculation data set that was generated at the time of the price calculation. The price calculation data set for the pricing of the sales transaction is then received 508. It is noted that one or more processes may be required to ensure security and data integrity of the price calculation data set, decrypting the data set, checking data integrity of the data set, and similar processes.

In some embodiments, utilizing the retrieved price calculation data set, the process further includes establishing the relevant context for the price calculation operation based context data in the data set 512 and selecting a sales item for the audit or explanation 516. In some embodiments, calculation data for the sales item is identified in the price calculation data set 520, and a record representing the price calculation for the sales item is generated based on the identified calculation 524. For example, the record may represent every factor and calculation in the generation of the pricing result for the sales item. If there are additional sales items to be considered in the request 528, a next sales item is selected 532 and the process continues with identifying the calculation data for the selected sales item 520.

If there are no additional sales items to be considered in the request 528, the generated data for the price calculations is aggregated 536, and a report is then generated for the audit or explanation addressing all or a portion of the price calculation for the sales transaction 540. In some embodiments, audit or explanation may include a visualization of the pricing operation illustrated in FIGS. 6A and 6B.

FIG. 6A is a flowchart to illustrate a process for generating a visualization of a price calculation operation utilizing a price calculation data set according to some embodiments. After the generation of a pricing result for a particular sales item, there may be a request from a customer or other party for a function including the generation of visualization of the pricing to allow a better explanation of the pricing. However, as with a request for an audit or explanation or pricing, the request may be received some time after the pricing result was generated, it may be very difficult to recreate the pricing process for the visualization. In some embodiments, a visualization of a pricing process is generated based on a price calculation data set, such as illustrated in FIGS. 3A and 3B.

In some embodiments, upon receipt of a request for a visualization of a previous price calculation process for a sales transaction 604, which may include all or any portion of the pricing process, and a price calculation data set for the sales transaction is retrieved 608. A first sales item is selected for visualization 612, and the calculation data for the pricing of the selected sales item is retrieved from the price calculation data set 616.

In some embodiments, an illustration of each calculation process in the pricing of the sales item is generated based on the retrieved calculation data 620. For example, each price calculation provided in FIG. 3B may be included in the visualization to provide a full calculation of the pricing for the sales item. The visualization may include, but is not limited to, a price waterfall illustration as provided in FIG. 6B.

If there are additional sales items to be considered in the request 624, a next sales item is selected 628 and the process continues with retrieving the calculation data for the selected sales item 618 and the generation of the illustration for the calculation process for such sales item 620. If there are no additional sales items to be considered 624, a report may be generated in response to the request, the report include each generated price calculation visualization 632.

FIG. 6B illustrates a price waterfall illustration generated based on a price calculation data set, according to some embodiments. As provided in FIG. 6A, a visualization may be generated including each calculation process in the pricing for a sales item. A generated price waterfall diagram, as illustrated in FIG. 6B, provides a pricing method decomposition diagram for the pricing of a particular sales item in a sales transaction. In some embodiments, the price waterfall diagram is generated based on the price calculation data set that is generated contemporaneously with the price calculation for the sales transaction.

In the illustrated price waterfall diagram, the price of a given product is reflected on the ‘y’ axis (i.e., the vertical axis) and the various adjustments to the list price are represented on the ‘x’ axis (horizontal axis). The bars with cross-hatching represent price reductions applied to the previous process in the price waterfall diagram. The shaded bars represent ‘price points’ and typically define the boundary between pricing functions that comprise the pricing method that results in this price waterfall diagram.

In the illustrated example, commencing with the list price, there are discount price reductions resulting in an invoice price; payment terms and consignment inventory price reductions resulting in the effective price; freight, expediting, and custom bar coding price reductions resulting in the net price; custom service and other price reductions resulting in the pocket price; and the cost of goods sold (COGS) resulting in the pocket margin. Many other pricing reductions and price points may be present in other examples. Each data element in the illustration is based on data from the price calculation data set, including:

Get List Price—Obtaining the List Price.

Calculate Invoice Price—Subtracting discounts from the List Price to generate the Invoice Price.

Calculate Effective Price—Subtracting payment terms and consignment inventory from the Invoice Price to generate the Effective Price.

Calculate Net Price—Subtracting freight, expediting, and custom barcoding from the Effective Price to generate the Net Price.

Calculate Pocket Price—Subtracting discounts from the List Price to generate the Invoice Price.

In the price waterfall diagram provided in FIG. 6B the contribution that each pricing function makes to the price waterfall is depicted along the ‘x’ axis, with the depicted price points representing the final output of each pricing function. The pricing functions are ordered (from left to right in FIG. 6B) with regard to execution within the particular pricing method. Each pricing function may contribute zero or more intermediate price calculations (for example, Payment Terms and Consignment Inventory within the Calculate Effective Price function), and each pricing function has a final price point that represents the final price calculation for that pricing function.

In this manner, a complete visualization of the pricing may be generated for each sales item in a sales transaction based on the price calculation data set for the sales transaction, which may, for example, be provided in connection with to a request for an audit or explanation of pricing of a sales transaction, as illustrated in FIG. 5.

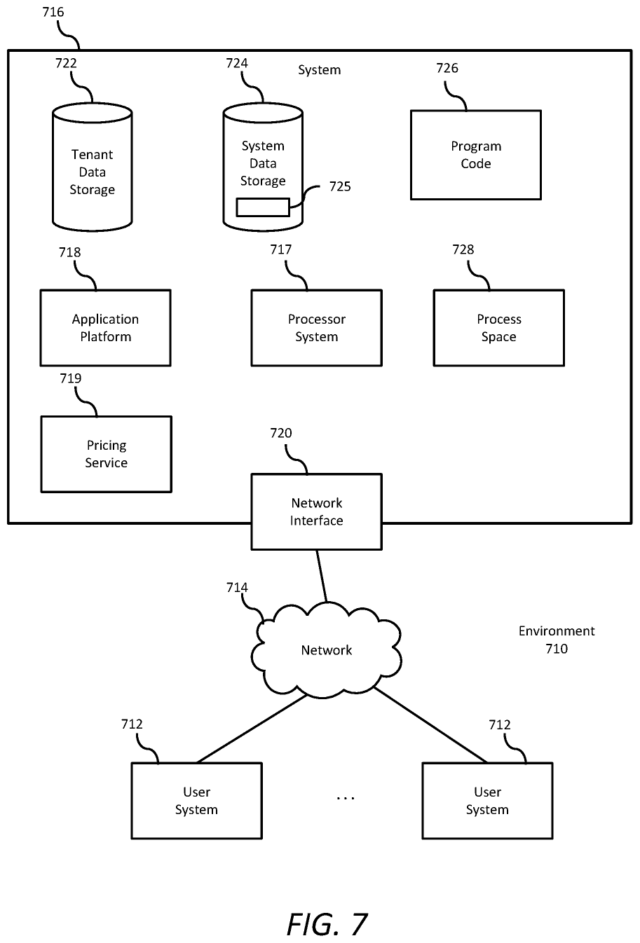

FIG. 7 illustrates a block diagram of an environment in which a preservation of price calculation data in performance of pricing operations may be implemented according to some embodiments. In some embodiments, the environment 710 includes preservation and utilization of price calculation data generated in pricing operations, such as illustrated in FIGS. 1-6B, including a pricing service 719, such as pricing service 120 illustrated in FIG. 1. The environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

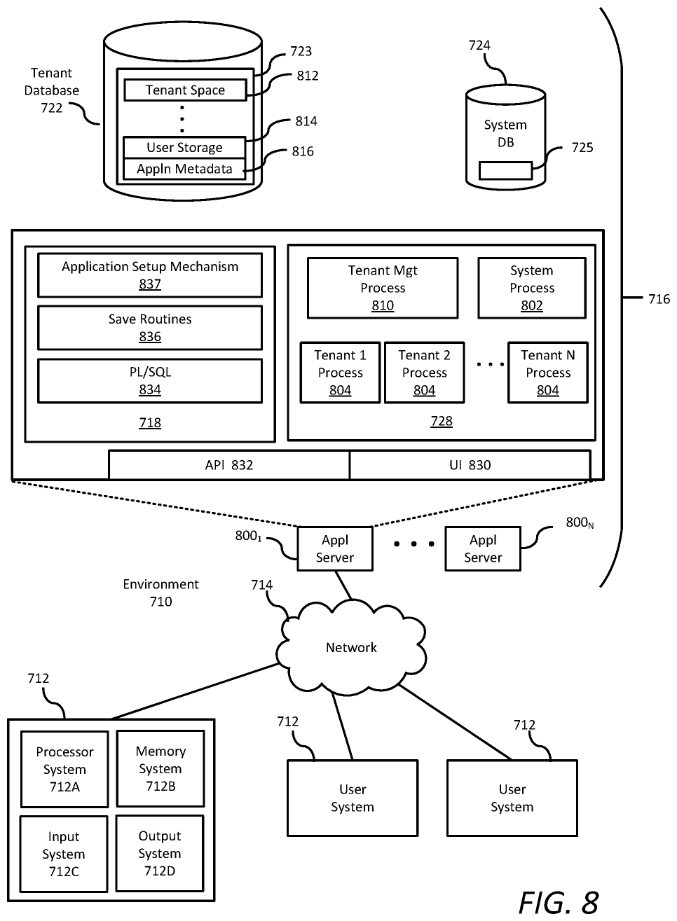

Environment 710 is an environment in which an on-demand database service exists. User system 712 may be any machine or system that is used by a user to access a database user system. For example, any of user systems 712 can be a handheld computing device, a smart phone, a laptop or tablet computer, a workstation, and/or a network of computing devices. As illustrated in herein FIG. 7 and in more detail in FIG. 8, user systems 712 may interact via a network 714 with an on-demand database service, such as system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” may be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third-party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third-party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop or tablet computer, smart phone, or any wireless access protocol (WAP) enabled device or any other computing device capable of interfacing directly or indirectly to the Internet or other network connection. User system 712 typically runs an HTTP client, e.g., a browsing program (also referred to as a web browser or browser), such as Edge or Internet Explorer from Microsoft, Safari from Apple, Chrome from Google, Firefox from Mozilla, or a WAP-enabled browser in the case of a smart phone or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, touch pad, touch screen, pen, voice interface, gesture recognition interface, or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Core series processor or the like. Similarly, system 716 (and additional instances of an MTS, where more than one is present) and all of their components might be operator configurable using application(s) including computer code to run using a central processing unit such as processor system 717, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk or solid state drive (SSD), but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 illustrates further details of an environment in which preservation of price calculation data in performance of pricing operations may be implemented according to some embodiments. FIG. 8 provides further detail regarding elements of system 716. In addition, various interconnections in an embodiment are provided. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Programming Interface (API) 832, PL/SOQL 834, save routines 836, application setup mechanism 838, applications servers 800₁-800_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long-term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 BIG-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, with US Patent granted U.S. Pat. No. 7,779,039, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

The examples illustrating the use of technology disclosed herein should not be taken as limiting or preferred. The examples are intended to sufficiently illustrate the technology disclosed without being overly complicated and are not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Implementations may include:

In some embodiments, a system includes one or more processors for processing of data; a memory for storage of data; an application programming interface (API) to receive requests for price calculations from one or more clients; a pricing service to generate pricing for transactions, wherein, in response to receiving a request for a first transaction from a first client, the first transaction including one or more sales items, including the system to generate a unique transaction identifier, record context data for calculation of the first transaction, calculate a pricing result for each of the one or more sales items, and collect price calculation data representing calculation of each of the one or more sales items, aggregate the pricing results for the one or more sales items to generate a final pricing result for the first transaction, generate a price calculation data set including at least the transaction identifier, the context data for the calculation of the first transaction, and the price calculation data for each of the one or more sales items, and store the price calculation data set in the memory; and a plurality of price data functions, each price data function to perform one or more operations based at least on part on the price calculation data set.

In some embodiments, one or more non-transitory computer-readable storage mediums having stored thereon executable computer program instructions that, when executed by one or more processors, cause the one or more processors to perform operations including receiving a request for a price calculation for a first transaction, the first transaction including one or more sales items; generating a unique transaction identifier; recording context data for calculation of the first transaction; calculating a pricing result for each of the one or more sales items, and collecting price calculation data representing calculation of each of the one or more sales items; aggregating the pricing results for the one or more sales items to generate a final pricing result for the first transaction; generating a price calculation data set including at least the transaction identifier, the context data for the calculation of the first transaction, and the price calculation data for each of the one or more sales items; and, upon receiving a request, performing one or more of a plurality of price data functions, each price data function to perform one or more operations based at least on part on the price calculation data set.

In some embodiments, a method includes receiving a pricing request for a first transaction at a pricing service, the first transaction including a plurality of sales items; generating a unique transaction identifier; recording context data for calculation of the first transaction; calculating a pricing result for each of the plurality of sales items, and collecting price calculation data representing calculation of each of the plurality of sales items; aggregating the pricing results for the plurality of sales items to generate a final pricing result for the first transaction, and collecting calculation data representing the aggregation of the pricing results; automatically generating a price calculation data set including at least the transaction identifier, the context data for the calculation of the first transaction, and the price calculation data for each of the plurality of sales items and for the aggregation of pricing results; and, upon receiving a request, performing one or more of a plurality of price data functions, each price data function to perform one or more operations based at least on part on the price calculation data set.

Embodiments may be provided, for example, as a computer program product which may include one or more machine-readable media (including a non-transitory machine-readable or computer-readable storage medium) having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic tape, magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described but can be practiced with modification and alteration within the spirit and scope of the appended claims. The description is thus to be regarded as illustrative instead of limiting.

What is claimed is:

1. A system comprising:
one or more processors for processing of data;
a memory for storage of data;
an application programming interface (API) to receive requests for price calculations from one or more clients;
a pricing service to generate price calculations for transactions, wherein, in response to receiving a request for price calculation for a first transaction from a first client, the first transaction including one or more sales items, the system to:
generate a unique transaction identifier for the first transaction,
record in the memory context data for the price calculation for the first transaction,
calculate a pricing result for each of the one or more sales items, and collect price calculation data representing calculation of each of the one or more sales items,
aggregate the pricing results for the one or more sales items to generate a final pricing result for the first transaction, and
generate a price calculation data set for the first transaction, including at least the transaction identifier, the context data for the calculation of the first transaction, and the price calculation data for each of the one or more sales items, and store the generated price calculation data set in the memory; and
a plurality of price data functions, each price data function to perform one or more operations based at least on part on the price calculation data set.

2. The system of claim 1, wherein the plurality of price data functions include a function to:
receive a request for a price calculation for a revised transaction, the request including the transaction identifier, the revised transaction including one or more differences with the first transaction; and
retrieve the price calculation data set for the first transaction from the memory based on the transaction identifier; and
perform the price calculation for the revised transaction based at least in part on the price calculation data set for the first transaction to generate an incremental price calculation result.

3. The system of claim 2, wherein performing the price calculation for the revised transaction includes:
identifying the one or more differences between the first transaction and the revised transaction and determining an effect on price calculation for each sales item caused by the one or more differences;
performing a delta calculation for one or more sales items affected by the one or more differences; and
generating the incremental price calculation result for the revised transaction by aggregating results of the delta calculations for the one or more sales items affected by the one or more differences together with data from the price calculation data set for calculations in the revised transaction that were unchanged from the first transaction.

4. The system of claim 1, wherein the plurality of price data functions include a function to:
receive a request for an audit or explanation of all or a portion of the pricing result for the first transaction, the request including the transaction identifier for the first transaction;
retrieve the price calculation data set for the first transaction from the memory based on the transaction identifier; and
generate a report in response to the request for audit or explanation based at least in part on the price calculation data set for the first transaction.

5. The system of claim 4, wherein generating the report includes at least:
identifying calculation data from the price calculation data set for at least one sales item of the one or more sales items of the first transaction; and
generating a record based at least in part on the identified calculation data.

6. The system of claim 4, wherein the plurality of price data functions include a function to:
receive a request for generation of a visualization of a calculation for at least one of the sales items of the first transaction;
identify calculation data from the price calculation data set for the sales item; and
generate an illustration of the calculation of the pricing result for the sales item based at least in part on the identified calculation data from the price calculation data set.

7. The system of claim 6, wherein generation of the illustration includes generation of a price waterfall diagram for the sales item.

8. The system of claim 1, wherein the context data for the price calculation for the first transaction includes one or more of a client identifier, a data or time of the price calculation, sales contract terms, or sales history information.

9. One or more non-transitory computer-readable storage mediums having stored thereon executable computer program instructions that, when executed by one or more processors, cause the one or more processors to perform operations comprising:
receiving, at a system including a pricing service, a request for a price calculation for a first transaction, the first transaction including one or more sales items;
generating a unique transaction identifier for the first transaction;
recording in a memory context data for the price calculation for the first transaction;
calculating a pricing result for each of the one or more sales items, and collecting price calculation data representing calculation of each of the one or more sales items;
aggregating the pricing results for the one or more sales items to generate a final pricing result for the first transaction;
generating a price calculation data set for the first transaction, including at least the transaction identifier, the context data for the calculation of the first transaction, and the price calculation data for each of the one or more sales items;
storing the generated price calculation data set for the first transaction in the memory; and
upon receiving a request, performing one or more of a plurality of price data functions, each price data function to perform one or more operations based at least on part on the price calculation data set.

10. The one or more storage mediums of claim 9, wherein the plurality of price data functions include a function to:
receive a request for a price calculation for a revised transaction, the request including the transaction identifier, the revised transaction including one or more differences with the first transaction;
retrieve the price calculation data set for the first transaction from the memory based on the transaction identifier; and
perform the price calculation for the revised transaction based at least in part on the price calculation data set for the first transaction to generate an incremental price calculation result.

11. The one or more storage mediums of claim 10, wherein performing the price calculation for the revised transaction includes:
identifying the one or more differences between the first transaction and the revised transaction and determining an effect on price calculation for each sales item caused by the one or more differences;
performing a delta calculation for one or more sales items affected by the one or more differences; and
generating the incremental price calculation result for the revised transaction by aggregating results of the delta calculations for the one or more sales items affected by the one or more differences together with data from the price calculation data set for calculations in the revised transaction that were unchanged from the first transaction.

12. The one or more storage mediums of claim 10, further comprising instructions for:
generating a second price calculation data set for the price calculation for the revised transaction.

13. The one or more storage mediums of claim 9, wherein the plurality of price data functions include a function to:
receive a request for an audit or explanation of all or a portion of the pricing result for the first transaction, the request including the transaction identifier for the first transaction;
retrieve the price calculation data set for the first transaction from the memory; and
generate a report in response to the request for audit or explanation based at least in part on the price calculation data set for the first transaction.

14. The one or more storage mediums of claim 13, wherein generating the report includes at least:
identifying calculation data from the price calculation data set for at least one sales item of the one or more sales items of the first transaction; and
generating the record based at least in part on the identified calculation data.

15. The one or more storage mediums of claim 13, wherein the plurality of price data functions include a function to:
receive a request for generation of a visualization of a calculation for at least one of the sales items of the first transaction;
identify calculation data from the price calculation data set for the sales item; and
generate an illustration of the calculation of the pricing result for the sales item based at least in part on the identified calculation data from the price calculation data set.

16. A method comprising:
receiving, at a computing system including a pricing service, a request for a price calculation for a first transaction, the first transaction including a plurality of sales items;
generating a unique transaction identifier for the first transaction;
recording in a memory context data for the price calculation for the first transaction;
calculating a pricing result for each of the plurality of sales items, and collecting price calculation data representing calculation of each of the plurality of sales items;
aggregating the pricing results for the plurality of sales items to generate a final pricing result for the first transaction, and collecting calculation data representing the aggregation of the pricing results;
automatically generating a price calculation data set including at least the transaction identifier, the context data for the calculation of the first transaction, and the price calculation data for each of the plurality of sales items and for the aggregation of pricing results;
storing the generated price calculation data set for the first transaction in the memory; and
upon receiving a request, performing one or more of a plurality of price data functions, each price data function to perform one or more operations based at least on part on the price calculation data set.

17. The method of claim 16, wherein the plurality of price data functions include a function to:
receive a request for a price calculation for a revised transaction, the request requesting incremental price calculation and including the transaction identifier, the revised transaction including one or more differences with the first transaction;
retrieve the price calculation data set for the first transaction from the memory based on the transaction identifier; and
perform the price calculation for the revised transaction based at least in part on the price calculation data set for the first transaction to generate an incremental price calculation result.

18. The method of claim 17, wherein performing the price calculation for the revised transaction includes:
identifying the one or more differences between the first transaction and the revised transaction and determining an effect on price calculation for each sales item caused by the one or more differences;
performing a delta calculation for one or more sales items affected by the one or more differences; and
generating the incremental price calculation result for the revised transaction by aggregating results of the delta calculations for the one or more sales items affected by the one or more differences together with data from the price calculation data set for calculations in the revised transaction that were unchanged from the first transaction.

19. The method of claim 16, wherein the plurality of price data functions include a function to:
receive a request for an audit or explanation of all or a portion of the pricing result for the first transaction, the request including the transaction identifier for the first transaction;
retrieve the price calculation data set for the first transaction from the memory;
identify calculation data from the price calculation data set for at least one sales item of the plurality of sales items of the first transaction; and
generate a record based at least in part on the identified calculation data.

20. The method of claim 16, wherein the plurality of price data functions include a function to:
receive a request for generation of a visualization of a calculation for at least one of the sales items of the first transaction;
identify calculation data from the price calculation data set for the sales item; and
generate an illustration of the calculation of the pricing result for the sales item based at least in part on the identified calculation data from the price calculation data set.
